(19) United States
(12) Patent Application Publication
(10) Pub. No.: US 2026/0228055 A1
(43) Pub. Date: Aug. 6, 2026

(54) MANAGING RESOURCE ALLOCATION FOR DATA PROCESSING SYSTEMS BASED ON SERVICE DEPENDENCIES

(71) Applicant: Dell Products L.P., Round Rock, TX (US)

(72) Inventors: SRIKRISHNA CHAITANYA GARIMELLA, Bengaluru (IN); VIVEKANANDH NARAYANASAMY RAJAGOPALAN, Bangalore (IN)

(21) Appl. No.: 19/043,725

(22) Filed: Feb. 3, 2025

(51) Int. Cl. G06F 9/50

(52) U.S. Cl. CPC G06F 9/505; G06F 9/5044; G06F 9/5072

(57) ABSTRACT

Methods and systems for managing service systems are disclosed. An occurrence of a load event for a computer-implemented service of computer-implemented services provided by the service systems may be identified. Based on the identification, new operating parameters for the service systems may be obtained based on dynamically identified limits of support systems that provide supporting services for the computer-implemented services. The new operating parameters may define allocation of computing resources for providing the computer-implemented service. Operation of the service systems may be modified based on the new operating parameters to increase a likelihood of the service systems providing the computer-implemented service as desired (e.g., while minimizing excess computing resource allocation to the computer-implemented service).

### FIELD

Embodiments disclosed herein relate generally to managing data processing systems. More particularly, embodiments disclosed herein relate to systems and methods to manage allocation of computing resources of the data processing systems.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating a distributed system in accordance with an embodiment.

FIG. 2A shows an interaction diagram in accordance with an embodiment.

FIG. 2B shows a data flow diagram in accordance with an embodiment.

FIG. 3 shows a flow diagram illustrating a method in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing data processing systems that may provide computer-implemented services. The data processing systems may include service systems that provide primary services (e.g., computer-implemented services) to downstream consumers of the primary services (e.g., users, other data processing systems). The primary services may consume supporting services provided by other systems (e.g., support systems). For example, support systems may provide database services, message broker services, and/or other types of services on which the primary services depend (e.g., primary service dependencies).

Over time, demand for the primary services may change. A capacity for providing the primary services (e.g., meeting demand) may be based on a quantity (and/or type) of computing resources allocated to providing the primary services. Therefore, to manage the changes in demand for the primary services over time, automatic scaling mechanisms for the primary services may be implemented. For example, a managing entity of the services systems may dynamically allocate varying quantities of computing resources (e.g., software components, hardware components) of the service systems to providing the primary services over time based on factors that may vary over time. For example, the managing entity may scale up provisioning of a primary service (e.g., allocate additional computing resources to providing the primary service) to increase the capacity for providing the primary service in order to meet an increased demand for the primary service.

However, the capacity for providing the primary services may be limited by a capacity for providing the supporting services. The support systems may be managed by an entity different to the managing entity of the service systems, and changes in the capacity for providing the supporting services over time may not be within control of the managing entity of the service systems. For example, the capacity for providing the supporting services may change based on changes in consumption of the supporting services by other computer-implemented services and/or changes in computing resource allocation to providing the supporting services (e.g., controlled by the entity that manages the support systems).

Therefore, if limitations of the support systems are not considered when allocating computing resources to providing the primary services, then finite quantities of computing resources may be used inefficiently and/or the primary services may not be provided as desired. For example, even when additional computing resources are allocated to the primary service to meet an increase in demand for the primary service, a subsequent demand for supporting services by the primary services may not be met due to limits of the support systems. Thus, the increased demand for the primary services may not be fully met despite the allocation of the additional computing resources, resulting in excess computing resource allocation to the primary service. Consequently, at least a portion of finite computing resources of the service systems may be used inefficiently and/or may be unavailable for allocation to providing other primary services.

Thus, to increase a likelihood of providing the primary service as desired (e.g., by reducing inefficient use of the finite computing resources), allocation of the computing resources of the service systems may be performed based on dynamically identified limits of the support systems. To do so, a management system may make identifications of occurrences of load events for the primary services that may be likely to impact capacities for providing the primary services and/or the supporting services. Based on the identification of the load events, the management system may obtain new operating parameters for the service systems that define allocation of computing resources for providing the primary services. The new operating parameters may be constrained by operational limits imposed on the service systems by the support systems (e.g., based on a dynamic capacity for providing the supporting services).

By considering limitations of the support systems when performing dynamic computing resource allocation for the service systems, the finite computing resources of the service systems may be more likely to be allocated in a manner that minimizes excess computing resource allocation to the primary services, thereby increasing a likelihood of providing the primary services as desired.

In an embodiment, a method for managing service systems is provided. The method may include making an identification of an occurrence of a load event for a computer-implemented service of computer-implemented services provided by the service systems, and based on the identification: obtaining new operating parameters for the service systems based on dynamically identified limits of support systems that provide supporting services for the computer-implemented services; and, modifying operation of the service systems based on the new operating parameters to increase a likelihood of the service systems providing the computer-implemented service as desired.

The occurrence of the load event may reduce a likelihood of providing the computer-implemented service as desired. Providing the computer-implemented service as desired may include minimizing excess computing resource allocation to the computer-implemented service.

The new operating parameters may define allocation of computing resources for providing the computer-implemented service.

Making the identification may include identifying changes in demand for the computer-implemented service over time. Making the identification may include identifying changes in capacity for providing the supporting services over time.

The dynamically identified limits of the support systems may be based on a capacity for providing the supporting services over time, and the capacity for providing the supporting services may change over time based on consumption of the supporting services by other computer-implemented services. A capacity for providing the computer-implemented service may be limited by the capacity for providing the supporting services.

Obtaining the new operating parameters may include: identifying operational requirements for the service systems based on a demand for the computer-implemented service; identifying operational limits for the service systems based on the capacity for providing the supporting services; and, modifying the operational requirements for the service systems based on the operational limits.

In an instance of the modifying of the operation of the service systems where the demand for the computer-implemented service exceeds the capacity for providing the computer-implemented service, the demand for the computer-implemented service may not be fully met.

A non-transitory media may include instructions that when executed by a processor cause the computer-implemented method to be performed.

The data processing system may include the non-transitory media and a processor, and may perform the computer-implemented method when the computer instructions are executed by the processor.

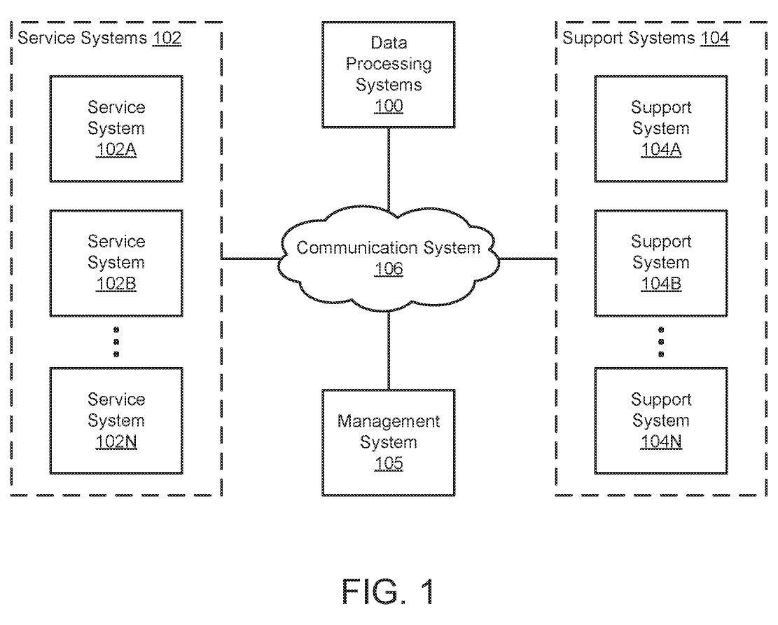

Turning to FIG. 1, a block diagram illustrating a distributed system in accordance with an embodiment is shown. The system shown in FIG. 1 may provide computer-implemented services. The computer-implemented services may include any type and quantity of computer-implemented services. For example, the computer-implemented services may include communication services, data storage services, database services, data generation services, and/or any other type of service that may be implemented with a computing device.

To provide the (computer-implemented) services, the system may include any number of data processing systems (e.g., service systems). The data processing systems may include any quantity of computing resources (e.g., software components and/or hardware components). The computing resources may be finite and may include, for example, processors, memory modules, storage devices, communications devices, power components, software applications, device drivers, and/or any other type of component whose respective operation may facilitate various functionalities of the data processing systems.

For example, to provide the services, a data processing system may obtain and fulfill requests for the services from downstream consumers of the services. To service the requests, the computing resources may perform a magnitude of computational work in a period of time, placing a load on the data processing system. Depending on types and/or quantities of the computing resources allocated to providing the service, the data processing system may be able to service a maximum number of requests in a period of time without becoming overloaded. If the data processing system becomes overloaded with requests for the service, then the service may be of reduced quality. For example, requests may be rejected and/or an average service time per request may increase, causing prevention of and/or delays in provisioning of the service.

To provide the services, the data processing systems may depend on supporting services from other systems (e.g., support systems). In other words, the data processing systems may provide primary services, and the primary services may consume supporting services in order to service the requests for the primary services. The supporting services may include database services, message brokering services, web services integrated through an application programming interface, and/or other services on which the primary services depend (e.g., primary service dependencies). For example, to service a single request for the primary service, the data processing systems may provide one or more requests for supporting services to the support systems. Therefore, a capacity for providing the primary service may depend on a capacity for providing the supporting services.

Over time, computing resources may be dynamically allocated to providing the primary services in order to meet operational goals. For example, a management system of the service systems may allocate additional computing resources to providing a primary service (e.g., the primary service may be scaled up) to improve performance and/or to handle an increased load caused by an increase in demand for the primary service. Or, for example, the management system may free a portion of computing resources allocated to providing the primary service when demand for the primary service decreases in order to minimize excess computing resources allocated to providing the primary service and/or to allocate the freed computing resources to other primary services.

However, the capacity for providing the primary service may be limited by the capacity for providing the supporting services, and the capacity for providing the supporting services may change over time based on factors out of the control of the management system. For example, the capacity for providing the supporting services may be based on consumption of the supporting services by other computer-implemented services over time and/or based on computing resource allocation to the supporting services over time (e.g., managed by an entity other than the management system).

Therefore, when automatic scaling mechanisms are implemented without considering whether the primary service dependencies are able to support the scaled primary services, excess computing resources may be allocated to the primary services. As a result, the primary services may not be provided as desired, for example, due to inefficient allocation and/or use of computing resources (e.g., increased operating costs, over-allocation or under-allocation of finite computing resources).

In general, embodiments disclosed herein may provide methods, systems, and/or devices for managing (computing) resource allocation for service systems that provide primary services based on dynamically identified limits of support systems that provide the primary service dependencies. To do so, a management system may make identifications of occurrences of load events for a primary service provided by the service systems. The load events may include any event that, upon occurrence of the event, may reduce a likelihood of providing the primary service as desired, such as changes in loads on the service systems (e.g., outside of a threshold). Based on the occurrence of the load event, the management system may obtain new operating parameters that define allocation of computing resources for providing the primary service.

To obtain the new operating parameters, the management system may identify operational limits for the service systems based on a real-time capacity of the support systems to provide the supporting services. The new operating parameters may be based on operational requirements for providing the primary service (e.g., to meet a real-time demand for the primary service); however the new operating parameters may be constrained by the operational limits, thereby minimizing excess computing resource allocation to the primary service. By doing so, the computing resources may be more likely to be allocated efficiently (e.g., adequately and/or not in excess) and the primary services may be more likely to be provided as desired.

To provide the above-mentioned functionality, the distributed system of FIG. 1 may include data processing systems 100, service systems 102, support systems 104, management system 105, and communication system 106. The distributed system, any components thereof, and/or any other types of devices or components not shown in FIG. 1 may perform all, or a portion of the computer-implemented services independently and/or cooperatively. Each of these components is discussed below.

Data processing systems 100 may include any number of data processing systems. Data processing systems 100 may host (and/or otherwise operate) any number of systems that provide, at least in part, computer-implemented services. For example, data processing systems 100 may obtain a first portion of services from any of service systems 102 and/or provide a second portion of the services to other entities (e.g., a user of data processing systems 100).

To obtain the services from service systems 102, data processing systems 100 may, for example, provide service requests to service systems 102. For example, data processing systems 100 may be operated by different users to browse a website, and each of data processing systems 100 may request different types of website services from service systems 102 over time. Volumes and/or types of requests generated by data processing systems 100 may vary over time (e.g., based on a demand for the website services), causing variations in load on service systems 102 over time.

Service systems 102 may include any number of data processing systems (e.g., service systems 102A-102N) that host primary services (e.g., computer-implemented services). Service systems 102 may provide a plurality of primary services independently and/or cooperatively (e.g., in some combination). For example, any of service systems 102 may service requests for a primary service from downstream consumers (e.g. data processing systems 100, users thereof, and/or other data processing systems). Service systems 102 may include Cloud service providers that provide, for example, storage services, networking services, compute services, and/or other types of computer-implemented services.

Service systems 102 may be managed by a management system. Service systems 102 may receive workloads for execution (e.g., requests for servicing), and the management system may provide a mechanism that deploys, maintains, and/or scales applications hosted by service systems 102 based on requirements of different types of workloads and computing resources allocated to the different types of workloads. For example, computing resources of service systems 102 may be allocated dynamically over time to service requests for different primary services in order to meet operational goals (e.g., to meet demand for the primary services, to reduce operational costs, to meet environmental goals).

For example, computing resources of service system 102A may be allocated to providing website services for users of data processing systems 100. Over time, service system 102A may experience an increase in requests per minute for viewing a product page (e.g., during a product sale), and if the number of requests per minute exceeds a capacity of service systems 102A to service the requests timely, then service system 102A to become overloaded. Therefore, to reduce the load on service system 102A, additional computing resources of any of service systems 102B-102N may be allocated to providing the website services (e.g., allocated to servicing a portion of the requests).

Support systems 104 may include any number of data processing systems (e.g., support systems 104A-104N) that host supporting services for the primary services provided by service systems 102 and/or other computer-implemented services provided by other data processing systems (not shown). For example, support systems 104 may provide supporting services such as message broker services, message queue services, database services, and/or other types of services on which service systems 102 depend to provide the primary services (e.g., primary service dependencies).

Support systems 104 may be managed by any number of entities different to the management entity of service systems 102. For example, the entities managing support systems 104 may manage allocation of computing resources of support systems 104 to providing the supporting services. A capacity for providing the supporting services (e.g., to support the primary services) may change over time, for example, based on computing resources allocated to providing the supporting services and/or consumption of the supporting services by the other computer-implemented services.

Management system 105 may include any number of data processing systems and may provide a variety of services for service systems 102. For example, management system 105 may provide monitoring services, data analysis services, computing resource allocation (e.g., auto-scaling) services, and/or other types of services for managing service systems 102. Management system 105 may provide the services, for example, to manage dynamic computing resource allocation for service systems 102 based on limits of support systems 104.

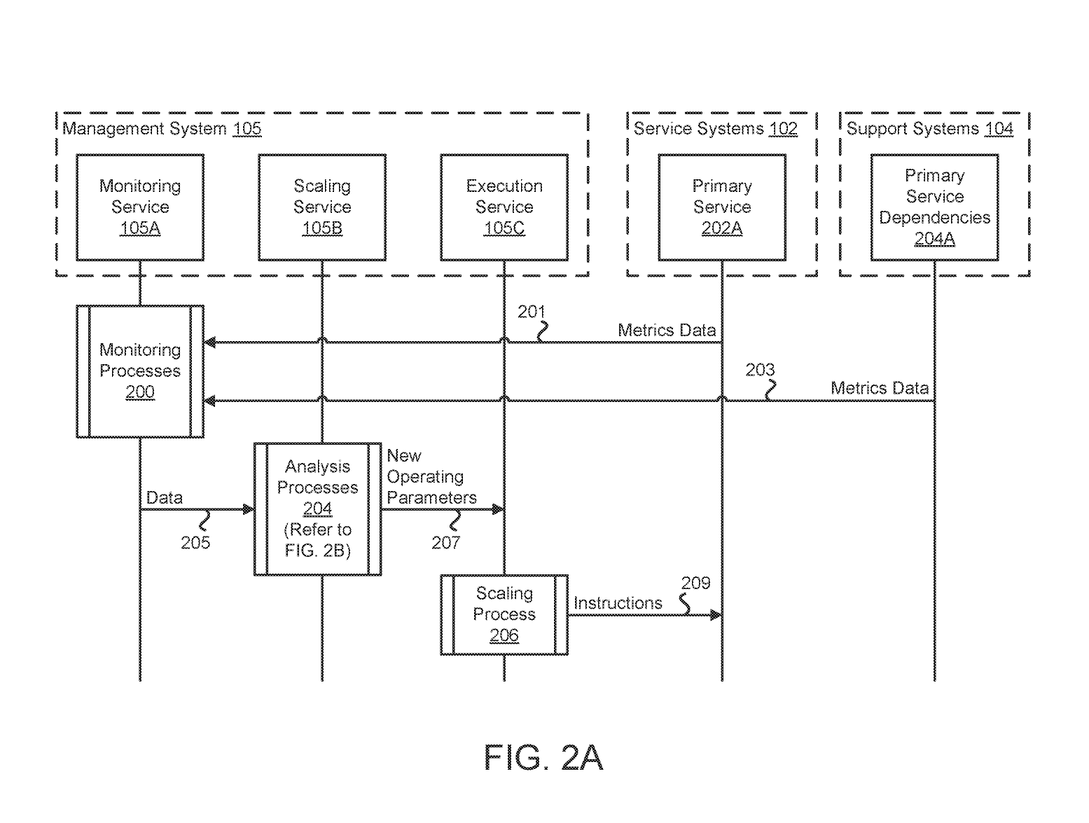

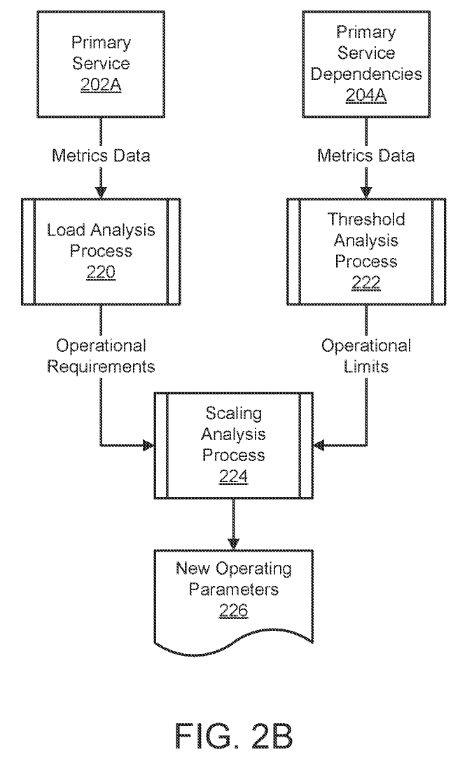

To manage dynamic computing resource allocation for service systems 102, operation of service systems 102 and/or support systems 104 may be monitored over time. For example, real-time metrics data (e.g., data regarding the operation of the systems) obtained through the monitoring may be analyzed to identify occurrences of load events for a primary service that may reduce a likelihood of providing the primary service as desired. For example, service systems 102 and/or support systems 104 may include functionality for reporting the metrics data to management system 105 for analysis. Refer to the description of FIG. 2A for more information regarding obtaining metrics data.

To perform its functionality, management system 105 may (i) obtain (e.g., collect) metrics data for service systems 102 and/or support systems 104 over time (e.g., via monitoring processes), (ii) analyze data (e.g., the metrics data) to identify occurrences of load events for a primary service provided by service systems 102, (iii) identify limits of support systems 104 over time (e.g., maximum limits on a capacity for providing supporting services for the primary service), (iv) obtain new operating parameters for service systems 102 based on the identified limits of support systems 104, (v) modify operation of service systems 102 based on the new operating parameters, and/or (vi) perform other actions for managing provisioning of the primary service.

The new operating parameters may be obtained through performance of various analysis processes and using the metrics data. For example, the new operating parameters may define allocation of computing resources for providing the primary service based on operational requirements (e.g., for satisfying a demand for the primary service) and operational limits (e.g., imposed based on the capacity for providing the supporting services) for service systems 102. The operation of service systems 102 may be modified, for example, via allocation of computing resources to providing the primary service as defined by the new operating parameters. Refer to the description of FIG. 2B for more information regarding obtaining new operating parameters.

By doing so, computing resources of service systems 102 may be less likely to be misallocated (e.g., allocated in excess) to providing the primary services, increasing a likelihood of providing the primary services as desired.

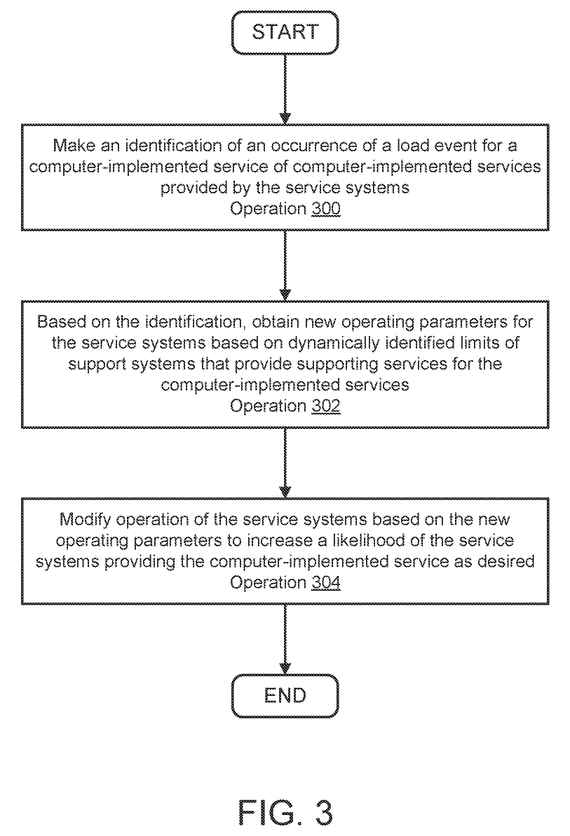

When providing their functionality, any of data processing systems 100, service systems 102, support systems 104, management system 105, and/or components thereof may perform all, or a portion of the actions and methods illustrated in FIGS. 2A-3.

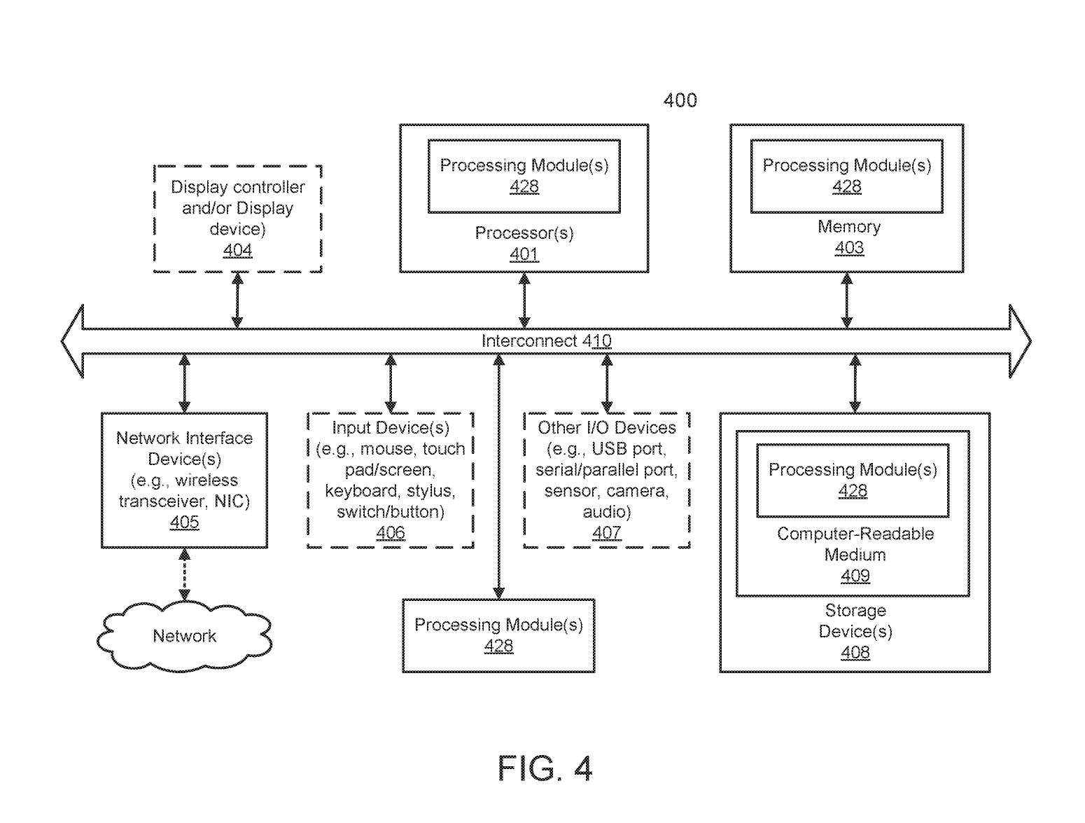

Any of data processing systems 100, service systems 102, support systems 104, and management system 105 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., smartphone), an embedded system, local controllers, an edge node, and/or any other type of data processing device or system. For additional details regarding computing devices, refer to the discussion of FIG. 4.

Any of the components illustrated in FIG. 1 may be operably connected to each other (and/or components not illustrated) with communication system 106. Communication system 106 may facilitate communications between the components of FIG. 1. In an embodiment, communication system 106 includes one or more networks that facilitate communication between any number of components. The networks may include wired networks and/or wireless networks (e.g., and/or the Internet). The networks and communication devices may operate in accordance with any number and types of communication protocols (e.g., such as the Internet protocol).

While illustrated in FIG. 1 as including a limited number of specific components, a system in accordance with an embodiment may include fewer, additional, and/or different components than those illustrated therein.

To further clarify embodiments disclosed herein, an interaction diagram in accordance with an embodiment is shown in FIG. 2A. The interaction diagram may illustrate how data may be obtained and used within the system of FIG. 1.

In the interaction diagram, processes performed by and interactions between components of a system in accordance with an embodiment are shown. In the diagrams, components of the system are illustrated using a first set of shapes (e.g., 105A, 105B, etc.), located towards the top of each figure. Lines descend from these shapes. Processes performed by the components of the system are illustrated using a second set of shapes (e.g., 200, 204, etc.) superimposed over these lines. Interactions (e.g., communication, data transmissions, etc.) between the components of the system are illustrated using a third set of shapes (e.g., 201, 203, etc.) that extend between the lines. For example, lines terminating in a single arrow may indicate that one-way interactions (e.g., data transmission from a first component to a second component) occur.

Generally, the processes and interactions are temporally ordered in an example order, with time increasing from the top to the bottom of each page. For example, the interaction labeled as 201 may occur prior to the interaction labeled as 203. However, it will be appreciated that the processes and interactions may be performed in different orders, any may be omitted, and other processes or interactions may be performed without departing from embodiments disclosed herein.

Turning to FIG. 2A, an interaction diagram in accordance with an embodiment is shown. The interaction diagram may illustrate processes and interactions that may occur during management of computing resource allocation. In the example shown in FIG. 2A, service systems 102 may provide primary service 202A (e.g., a computer-implemented service) to a downstream consumer (not shown), and support systems 104 may provide primary service dependencies 204A (e.g., supporting services) that support provisioning of primary service 202A.

To manage service systems 102, management system 105 may include various service components. For example, the service components may include service modules such as monitoring service 105A, scaling service 105B, execution service 105C, and/or other service modules not shown in FIG. 2A. Services provided by each of the service components of management system 105 are discussed below.

Management system 105 may provide monitoring service 105A. Monitoring service 105A may collect metrics data for any number of systems over time. For example, monitoring service 105A may collect real-time metrics data for service systems 102 and/or for support systems 104. Monitoring service 105A may use the metrics data to identify occurrences of load events for services provided by service systems 102 (e.g., primary service 202A), and/or to provide other types of services regarding operation of service systems 102 and/or support systems 104.

To obtain the metrics data, monitoring service 105A may perform monitoring processes 200. During monitoring processes 200, management system 105 may obtain metrics data for service systems 102 from service systems 102 and/or from other devices (e.g., hosting third-party management applications monitoring health and/or performance of different components of service systems 102). For example, the metrics data may be obtained while service systems 102 are providing primary service 202A and/or other primary services (not shown).

The metrics data for service systems 102 may include (i) information regarding demand for primary service 202A, (ii) information regarding operation and/or availability of computing resources of service systems 102 (e.g., for provisioning of the primary services), and/or (iii) other information usable to assess health and/or performance of service systems 102. For example, the metrics data may include a number of requests (e.g., received, serviced, rejected) per period of time, error rates, memory and/or processor usage, throughput, bandwidth utilization, latency, and/or other measures of health and/or performance of the computing resources allocated to providing primary service 202A. The metrics data may indicate a capacity for providing primary service 202A (e.g., based on allocation of computing resources over time).

At interaction 201, the metrics data for service systems 102 may be provided to monitoring service 105A by service systems 102. For example, the metrics data may be generated and provided to monitoring service 105A via (i) transmission via a message, (ii) storing in a storage with subsequent retrieval by monitoring service 105A, (iii) a publish-subscribe system where monitoring service 105A subscribes to updates from service systems 102 thereby causing a copy of the metrics data to be propagated to monitoring service 105A, and/or (iv) other processes.

During monitoring processes 200, monitoring service 105A may collect metrics data for support systems 104 from support systems 104 and/or from other devices. The metrics data for support systems 104 may be similar to the metrics data for service systems 102, and/or may indicate a capacity for providing primary service dependencies 204A. For example, the capacity for providing primary service dependencies 204A may be based on message queue sizes, processor utilization, memory utilization, response times, database connection pool sizes, request failure rates, etc. The metrics data for support systems 104 may include metrics data for each service of primary service dependencies 204A.

At interaction 203, the metrics data for support systems 104 may be provided to monitoring service 105A by support systems 104 using methods similar to those described with respect to interaction 201.

Monitoring processes 200 may include ongoing processes, during which metrics data may be obtained from service systems 102 and/or support systems 104 periodically (e.g., based on a schedule and/or based on other factors). In a first example, management system 105 may obtain the metrics data via an application hosted by management system 105 running on service systems 102. In a second example, monitoring processes 200 may be performed in cooperation with reporting processes (not shown). For example, the reporting processes may be performed periodically by any of service systems 102, support systems 104, and/or other systems (not shown). During the reporting processes, any of the systems may report their respective metrics data to management system 105.

Management system 105 may process, analyze, and/or store the (processed and/or analyzed) metrics data in a data repository (not shown). For example, monitoring service 105A may obtain statistical characterizations of the metrics data (e.g., average values, median values, ratios), and compare the statistical characterizations to predefined thresholds of operation to identify an occurrence of a load event for primary service 202A. The occurrence of the load event may be identified, for example, based on (i) changes in demand for primary service 202A over time, (ii) changes in capacity for providing primary service dependencies 204A over time, and/or (iii) other information. The occurrence of the load event may include any event that causes a change in load on service systems 102.

For example, management system 105 may analyze metrics data for service systems 102 to identify an increase or decrease in demand for primary service 202A (e.g., increasing or decreasing outside of demand thresholds based on currently allocated computing resources), and/or may analyze metrics data for support systems 104 to identify an increase or decrease in the capacity for providing the supporting services (e.g., increasing or decreasing outside of capacity thresholds based on a capacity required to provide primary service 202A).

The occurrence of the load event may reduce a likelihood of providing primary service 202A as desired. For example, primary service 202A may not be provided as desired when excess computing resources are allocated to providing primary service 202A and/or when demand for primary service 202A is unmet. To manage the occurrence of the load event, a data package may be obtained (e.g., generated) by monitoring service 105A. The data package may include the metrics data (e.g., processed and/or filtered metrics data), (ii) information regarding the occurrence of the load event (e.g., a notification of the occurrence of the load event), and/or (iii) other information.

Notification of the occurrence of the load event may prompt management system 105 to manage (e.g., redefine) computing resource allocation for providing primary service 202A. To manage resource allocation for primary service 202A (and/or other primary services provided by service systems 102), management system 105 may provide scaling service 105B.

At interaction 205, data (e.g., the data package), may be provided to scaling service 105B by monitoring service 105A. For example, the data may be generated and provided to scaling service 105B via (i) transmission via a message, (ii) storing in a storage with subsequent retrieval by scaling service 105B, (iii) a publish-subscribe system where scaling service 105B subscribes to updates from monitoring service 105A thereby causing a copy of the data to be propagated to scaling service 105B, and/or (iv) other processes. By providing the data to scaling service 105B, scaling service 105B may perform analysis processes 204 to obtain new operating parameters for service systems 102.

For example, during analysis processes 204, limits of support systems 104 may be dynamically identified based on the data (e.g., metrics data indicating a capacity for providing primary service dependencies 204A over time). Thus, the new operating parameters may define allocation of computing resources for providing primary service 202A in consideration of the dynamically identified limits of support systems 104. An example of analysis processes 204 is described with respect to FIG. 2B.

Based on the new operating parameters, the operation of service systems 102 may be modified. To automatically modify the operation of service systems 102 in timely response to the occurrence of the load event, management system 105 may provide execution service 105C. For example, execution service 105C may include an infrastructure as code (IaC) module usable for scaling computing resources of service systems 102.

At interaction 207, the new operating parameters may be provided to execution service 105C by scaling service 105B. For example, the new operating parameters may be generated and provided to execution service 105C via (i) transmission via a message, (ii) storing in a storage with subsequent retrieval by execution service 105C, (iii) a publish-subscribe system where execution service 105C subscribes to updates from scaling service 105B thereby causing a copy of the new operating parameters to be propagated to execution service 105C, and/or (iv) other processes. By providing the new operating parameters to execution service 105C, execution service 105C may initiate scaling process 206.

During scaling process 206, execution service 105C may obtain and/or execute instructions for modifying the operation of service systems 102. For example, during scaling process 206, execution service 105C may execute instructions included in the new operating parameters, use the new operating parameters to generate instructions for freeing and/or allocating computing resources accordingly, and/or provide instructions to other systems for execution.

For example, the instructions may include (i) instructions for clearing a workload queue for any of service systems 102 (e.g., to free computing resources already allocated to providing primary service 202A), (ii) instructions for reserving computing resources of any of service systems 102 (e.g., allocating additional computing resources to providing primary service 202A), and/or (iii) other instructions (e.g., application code, configuration code). For example, when increasing a quantity of computing resources allocated to providing primary service 202A (e.g., scaling up primary service 202A), additional instances of primary service 202A may be generated by providing existing and/or additional code to newly allocated computing resources for execution.

At interaction 209, the instructions may be provided to service systems 102 by execution service 105C. For example, the instructions may be provided to service systems 102 via (i) transmission via a message, (ii) storing in a storage with subsequent retrieval by service systems 102, (iii) a publish-subscribe system where service systems 102 subscribes to updates from execution service 105C thereby causing a copy of the instructions to be propagated to service systems 102, and/or (iv) other processes. Any portion of the instructions may be executed by service systems 102 in order to modify the operation of service systems 102.

Thus, computing resources allocated to providing primary service 202A over time may be constrained based on a capacity for providing primary service dependencies 204A over time. For example, when demand for primary service 202A exceeds a capacity for providing primary service 202A (e.g., due to constraints of the capacity for providing primary service dependencies 204A), the demand for primary service 202A may not be fully met; however, excess computing resource allocation to primary service 202A may be minimized, increasing a likelihood of service systems 102 providing primary service 202A as desired.

In FIG. 2A, while service systems 102 are shown to provide primary service 202A and support systems 104 are shown to provide primary service dependencies 204A, it will be appreciated that service systems 102 and/or support systems 104 may provide any number and/or type of computer-implemented services without departing from embodiments disclosed herein. Similarly, it will be appreciated that management system 105 may include any number and/or type of service components including and/or in addition to those shown in FIG. 2A without departing from embodiments disclosed herein.

Any of the processes illustrated using the second set of shapes and interactions illustrated using the third set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes and interactions illustrated using the third set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor-based devices (e.g., computer chips).

Any of the processes and interactions may be implemented using any type and number of data structures. The data structures may be implemented using, for example, tables, lists, linked lists, unstructured data, data bases, and/or other types of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

To further clarify embodiments disclosed herein, a data flow diagram in accordance with an embodiment is shown in FIG. 2B. In the diagram, flows of data and processing of data are illustrated using different sets of shapes. A first set of shapes (e.g., 226) is used to represent data structures, a second set of shapes (e.g., 220, 222, etc.) is used to represent processes performed using and/or that generate data, and a third set of shapes (e.g., 102A, 104A) is used to represent components (e.g., applications hosted by data processing systems) that provide computer-implemented services.

Turning to FIG. 2B, a data flow diagram in accordance with an embodiment is shown. The data flow diagram may illustrate data used in and data processing performed in obtaining new operating parameters for service systems that provide primary services (e.g., primary service 202A) supported by supporting services (e.g., primary service dependencies 204A). The data flow diagram may illustrate an example of analysis processes 204 of FIG. 2A. For example, an occurrence of a load event may be identified based on metrics data for the service systems and/or metrics data for support systems that provide primary service dependencies 204A.

To obtain the new operating parameters for the service systems, operational requirements for the service systems may be identified, and the operational requirements may be constrained by operational limits for the service systems.

To identify the operational requirements, load analysis process 220 may be performed. During load analysis process 220, metrics data for the service systems that provide primary service 202A may be obtained. As discussed with respect to FIG. 2A, the metrics data for the service systems may indicate a capacity for providing primary service 202A (e.g., based on computing resources already allocated to providing primary service 202A) and/or a demand for primary service 202A (e.g., a number of requests per minute for primary service 202A). The operational requirements may be identified based on the demand for primary service 202A.

In a first example, the occurrence of the load event may include an increase in demand for primary service 202A (e.g., beyond a capacity for providing primary service 202A using the computing resources already allocated to providing primary service 202A). The metrics data for the service systems may indicate that the service systems are capable of servicing (up to) 300 requests for primary service 202A per minute (e.g., on average) with the computing resources already allocated to providing primary service 202A. However, the metrics data may indicate that a number of incoming requests for primary service 202A has increased from 300 to 500 requests per minute (e.g., on average). Therefore, the operational requirements may indicate that primary service 202A should be scaled up (e.g., additional computing resources should be allocated to providing primary service 202A) in order to satisfy (up to) 500 requests per minute.

To identify the operational limits for the service systems, threshold analysis process 222 may be performed. During threshold analysis process 222, metrics data for support systems that provide primary service dependencies 204A may be obtained. As discussed with respect to FIG. 2A, the metrics data for the support systems may indicate a capacity for providing primary service dependencies 204A over time. During threshold analysis process 222, the capacity for providing primary service dependencies 204A (e.g., limits of the support systems) may be correlated to a capacity for supporting primary service 202A.

Returning to the first example, the metrics data for the support systems may indicate that the support systems are capable of servicing (up to) 800 requests for primary service dependencies 204A per minute, which correlates to supporting (up to) 400 requests for primary service 202A per minute (e.g., based on a function relating requests for primary service 202A and requests for primary service dependencies 204A). Therefore, the operational limits may indicate that a maximum threshold for providing primary service 202A is 400 requests per minute.

To constrain the operational requirements using the operational limits, scaling analysis process 224 may be performed. During scaling analysis process 224, the operational requirements may be modified based on the operational limits to determine new operating parameters 226. For example, the operational requirements may be compared to the operational limits, and if the operational requirements exceed the operational limits, then the operational requirements may be capped at (e.g., modified to match) the operational limits.

Returning to the first example, where the operational requirements indicate that primary service 202A should be scaled up in order to satisfy (up to) 500 requests per minute, and the operational limits indicate that primary service dependencies 204A can only support (up to) 400 requests for primary service 202A per minute. The operational requirements may be modified to indicate that primary service 202A should be scaled up to satisfy (up to) only 400 requests per minute.

During scaling analysis process 224, a quantity of computing resources of the service systems may be identified based on the (modified) operational requirements. For example, if the operational requirements indicate that primary service 202A is to be scaled down (e.g., due to a decrease in demand for primary service 202A), then a quantity of excess computing resources already allocated to providing primary service 202A may be identified.

Returning to the first example, when the operational requirements indicate that primary service 202A is to be scaled up to handle (up to) 400 requests per minute, a quantity of computing resources sufficient to increase a capacity for providing primary service 202A by 100 requests per minute may be identified.

Scaling analysis process 224 may include a resource scheduling process. For example, the resource scheduling process may identify computing resources of the service systems based on the quantity of computing resources and whether the quantity of computing resources is to be freed from or allocated to providing primary service 202A.

During scaling analysis process 224, new operating parameters 226 may be obtained. New operating parameters 226 may include information regarding computing resource allocation for providing primary service 202A. For example, new operating parameters 226 may include (i) identifiers for computing resources, (ii) information indicating whether the computing resources are to be allocated to providing primary service 202A, freed from providing primary service 202A, and/or allocated to another primary service, (iii) instructions for allocating or freeing the computing resources, and/or (iv) other information (e.g., other resource scheduling information such as temporal information for execution of the instructions).

New operating parameters 226 may be provided to a scaling process (e.g., scaling process 206 of FIG. 2A) for use in modifying operation of the service systems (e.g., managing computing resource allocation for the service systems).

Any of load analysis process 220, threshold analysis process 222, and/or scaling analysis process 224 may be performed over time as occurrences of load events are identified and/or as new metrics data is available for analysis. By doing so, the operational limits (e.g., limits on the support systems) and constrained operational requirements and may be dynamically identified over time.

In a second example and following the first example (e.g., where operational requirements for meeting a demand for primary service 202A are limited by a capacity for providing primary service dependencies 204A), a second load event may occur. The occurrence of the second load event may include an increase in the capacity for providing primary service dependencies 204A. In response to the occurrence of the second load event, load analysis process 220 may be performed, and the demand for primary service 202A may have remained static (e.g., at 500 requests per minute). However, during threshold analysis process 222, operational limits of primary service dependencies 204A may have increased to support (up to) 600 requests for primary service 202A per minute.

Therefore, in the second example and during scaling analysis process 224, the operational requirements may not be constrained by the operational limits, and primary service 202A may be scaled up to handle (up to) 500 requests per minute. By dynamically identifying limits for the support systems (e.g., limits on a capacity for providing primary service dependencies 204A) over time, the demand for primary service 202A may be more likely to be met without allocating excess computing resources to providing primary service 202A, increasing a likelihood of providing primary service 202A as desired.

In FIG. 2B, any of the processes illustrated using the second set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the data structures illustrated using the first set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

Thus, using the data flows shown in FIG. 2B, new operating parameters may be obtained for service systems that provide primary services based on dynamically identified limits of support systems that provide primary service dependencies. By doing so, excess allocation of computing resources to providing the primary services may be minimized, and computing resources of the service systems may be more likely to be allocated efficiently among the primary services.

Turning to FIG. 3, a flow diagram illustrating a method in accordance with an embodiment is shown. The flow diagram may illustrate various operations performed while managing service systems.

At operation 300, an identification of an occurrence of a load event for a computer-implemented service of computer-implemented services provided by the service systems may be made. The computer-implemented service may include a primary service, and the occurrence of the load event may reduce a likelihood of providing the primary service as desired (e.g., the primary service may be likely to be provided using excess computing resources).

The identification may be made by (i) obtaining a notification from another system indicating occurrence of the load event, and/or (ii) detecting the occurrence of the load event. For example, the occurrence of the load event may be detected by performing a monitoring process similar to monitoring processes 200 of FIG. 2A and/or by other methods.

Making the identification may include identifying changes in demand for the computer-implemented service over time. The changes in demand may be identified by (i) obtaining metrics data for the service systems, and/or (ii) analyzing the metrics data for the service systems. For example, the metrics data for the service systems may include information regarding a request rate (e.g., a number of requests received per minute) for the computer-implemented services over time, which may be analyzed to identify a demand for the computer-implemented service. Increases or decreases in the request rate (e.g., outside of request rate thresholds) may indicate an occurrence of a load event for the computer-implemented service.

Making the identification may include identifying changes in capacity for providing the supporting services over time. The changes in the capacity for providing the supporting services may be identified by (i) obtaining metrics data for support systems that provide supporting services for the computer-implemented service, and/or (ii) analyzing the metrics data for the support systems. For example, the metrics data for the support systems may indicate a request servicing rate (e.g., a maximum number of requests for supporting services that may be serviced in a period of time). Increases or decreases in the request servicing rate (e.g., outside of request rate thresholds) may indicate an occurrence of a load event for the computer-implemented service.

At operation 302, based on the identification, new operating parameters for the service systems may be obtained based on dynamically identified limits of the support systems that provide the supporting services for the computer-implemented services. The new operating parameters may be obtained by (i) reading the new operating parameters (e.g., from storage), (ii) receiving the new operating parameters (e.g., from another device), and/or (iii) generating the new operating parameters. For example, the new operating parameters may be generated by performing any number of analysis processes, similar to analysis processes 204 of FIG. 2A and/or by other methods. Refer to the discussion of FIG. 2B for an example of analysis processes that may be performed to obtain the new operating parameters.

Obtaining the new operating parameters may include (i) identifying operational requirements for the service systems based on a demand for the computer-implemented service, (ii) identifying operational limits for the service systems based on the capacity for providing the supporting services, and/or (iii) modifying the operational requirements for the service systems based on the operational limits.

The operational requirements for the service systems may be identified by performing a load analysis process similar to load analysis process 220 of FIG. 2B and/or by other methods. For example, the operational requirements may be identified by analyzing metrics data for the service systems to identify a demand for the computer-implemented service, and identifying a quantity (and/or type) of computing resources required to meet the demand for the computer-implemented service.

The operational limits for the service systems may be identified by performing a threshold analysis process similar to threshold analysis process 222 of FIG. 2B and/or by other methods. For example, the operational limits may be identified by analyzing metrics data for the support systems (e.g., by analyzing request service rates for the supporting services, current operation of the support systems, and/or operational capacities of the support systems) to identify the capacity for providing the supporting services. The operational limits for the service systems may be identified by evaluating a function that relates the capacity for providing the supporting services to a capacity for providing the computer-implemented service.

The operational requirements for the service systems may be modified by performing a scaling analysis process such as scaling analysis process 224 of FIG. 2B and/or by other methods. For example, the operational requirements may be modified based on the operational limits when the operational requirements exceed the operational limits. The new operating parameters may be obtained by identifying a quantity of computing resources required to meet the (modified) operational requirements.

At operation 304, operation of the service systems may be modified based on the new operating parameters to increase a likelihood of the service systems providing the computer-implemented service as desired. The operation may be modified by performing a scaling process such as scaling process 206 of FIG. 2A and/or by other methods.

For example, the operation may be modified by (i) identifying a quantity of computing resources already allocated to providing the computer-implemented service, (ii) obtaining a difference between the quantity of computing resources already allocated to providing the computer-implemented service and the quantity of computing resources required to meet the (modified) operational requirements, (iii) identifying computing resources of the service systems for allocation or freeing based on the difference, (iv) obtaining instructions for allocating or freeing the identified computing resources, and/or (v) providing the instructions to the service systems for execution.

The method may end following operation 304.

Thus, as illustrated above, embodiments disclosed herein may provide systems and methods for managing dynamic computing resource allocation for service systems that provide computer-implemented services dependent on supporting services. When allocating computing resources to providing the computer-implemented services, a quantity of computing resources required to meet a demand for the computer-implemented services may be limited by a capacity for providing the supporting services. By doing so, excess allocation of computing resources to providing the computer-implemented services may be minimized to reduce negative impacts of excessive allocation of computing resources (e.g., increased costs of providing the computer-implemented services, inefficient use of the computing resources). As a result, the computer-implemented services may be more likely to be provided as desired.

Any of the components illustrated in FIGS. 1-3 may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high-level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random-access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a Wi-Fi transceiver, an infrared transceiver, a Bluetooth transceiver, a WiMAX transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid-state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also, a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs, or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components, or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system’s registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g., circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing service systems, the method comprising:
making an identification of an occurrence of a load event for a computer-implemented service of computer-implemented services provided by the service systems; and
based on the identification:
obtaining new operating parameters for the service systems based on dynamically identified limits of support systems that provide supporting services for the computer-implemented service, and
modifying operation of the service systems based on the new operating parameters to increase a likelihood of the service systems providing the computer-implemented service as desired.

2. The method of claim 1, wherein the occurrence of the load event reduces a likelihood of providing the computer-implemented service as desired.

3. The method of claim 2, wherein providing the computer-implemented service as desired comprises minimizing excess computing resource allocation to the computer-implemented service.

4. The method of claim 1, wherein the new operating parameters define allocation of computing resources for providing the computer-implemented service.

5. The method of claim 1, wherein making the identification comprises:
identifying changes in demand for the computer-implemented service over time.

6. The method of claim 1, wherein making the identification comprises:
identifying changes in capacity for providing the supporting services over time.

7. The method of claim 1, wherein the dynamically identified limits of the support systems are based on a capacity for providing the supporting services over time, and the capacity for providing the supporting services changes over time based on consumption of the supporting services by other computer-implemented services.

8. The method of claim 7, wherein a capacity for providing the computer-implemented service is limited by the capacity for providing the supporting services.

9. The method of claim 8, wherein obtaining the new operating parameters comprises:
identifying operational requirements for the service systems based on a demand for the computer-implemented service;
identifying operational limits for the service systems based on the capacity for providing the supporting services; and
modifying the operational requirements for the service systems based on the operational limits.

10. The method of claim 9, wherein in an instance of the modifying of the operation of the service systems where the demand for the computer-implemented service exceeds the capacity for providing the computer-implemented service, the demand for the computer-implemented service is not fully met.

11. A non-transitory machine-readable medium having instructions stored therein, which when executed by a processor, cause the processor to perform operations for managing service systems, the operations comprising:
making an identification of an occurrence of a load event for a computer-implemented service of computer-implemented services provided by the service systems; and
based on the identification:
obtaining new operating parameters for the service systems based on dynamically identified limits of support systems that provide supporting services for the computer-implemented service, and
modifying operation of the service systems based on the new operating parameters to increase a likelihood of the service systems providing the computer-implemented service as desired.

12. The non-transitory machine-readable medium of claim 11, wherein the occurrence of the load event reduces a likelihood of providing the computer-implemented service as desired.

13. The non-transitory machine-readable medium of claim 12, wherein providing the computer-implemented service as desired comprises minimizing excess computing resource allocation to the computer-implemented service.

14. The non-transitory machine-readable medium of claim 11, wherein the new operating parameters define allocation of computing resources for providing the computer-implemented service.

15. The non-transitory machine-readable medium of claim 11, wherein making the identification comprises:
identifying changes in demand for the computer-implemented service over time.

16. A data processing system, comprising:
a processor; and
a memory coupled to the processor to store instructions, which when executed by the processor, cause operations for managing service systems to be performed, the operations comprising:
making an identification of an occurrence of a load event for a computer-implemented service of computer-implemented services provided by the service systems, and
based on the identification:
obtaining new operating parameters for the service systems based on dynamically identified limits of support systems that provide supporting services for the computer-implemented service; and
modifying operation of the service systems based on the new operating parameters to increase a likelihood of the service systems providing the computer-implemented service as desired.

17. The data processing system of claim 16, wherein the occurrence of the load event reduces a likelihood of providing the computer-implemented service as desired.

18. The data processing system of claim 17, wherein providing the computer-implemented service as desired comprises minimizing excess computing resource allocation to the computer-implemented service.

19. The data processing system of claim 16, wherein the new operating parameters define allocation of computing resources for providing the computer-implemented service.

20. The data processing system of claim 16, wherein making the identification comprises:
identifying changes in demand for the computer-implemented service over time.
